(19) United States
(12) Patent Application Publication
(10) Pub. No.: US 2013/0258671 A1
(43) Pub. Date: Oct. 3, 2013

(54) LIGHTING DEVICE AND METHOD FOR OPERATING A LIGHTING DEVICE

(71) Applicant: OSRAM GMBH, Muenchen (DE)

(72) Inventors: Frank Baumann, Regensburg (DE); Michael Schoewel, Regensburg (DE); Henrike Streppel, Regensburg (DE)

(73) Assignee: OSRAM GmbH, Muenchen (DE)

(21) Appl. No.: 13/855,769

(22) Filed: Apr. 3, 2013

(30) Foreign Application Priority Data
Apr. 3, 2012 (DE) 102012205469.3

(51) Int. Cl. F21V 29/02

(52) U.S. Cl. CPC F21V 29/02
USPC 362/293; 313/35

(57) ABSTRACT

In various embodiments, a lighting device is provided. The lighting device may include an air channel, which extends in an axial direction and which has at least one first opening in the region of a first axial end of the air channel and which has at least one second opening in the region of a second axial end of the air channel; at least one radiation arrangement, which emits electromagnetic radiation and which is arranged on an outer side of the air channel such that it emits the electromagnetic radiation in a direction away from the air channel; and at least one conversion element, which comprises phosphors and which is arranged around the air channel and the radiation arrangement at a predefined distance from the radiation arrangement such that the electromagnetic radiation impinges on the conversion element and excites the phosphors in the conversion element for emitting conversion radiation.

### CROSS-REFERENCE TO RELATED APPLICATION

This application claims priority to German Patent Application Serial No. 10 2012 205 469.3, which was filed Apr. 3, 2012, and is incorporated herein by reference in its entirety.

### TECHNICAL FIELD

Various embodiments relate to a lighting device including a radiation arrangement and a conversion element. The radiation arrangement emits electromagnetic radiation. The conversion element includes phosphors and is arranged such that the electromagnetic radiation impinges on the conversion element and excites the phosphors in the conversion element for emitting conversion radiation. Furthermore, various embodiments relates to a method for operating the lighting device.

### BACKGROUND

Nowadays, conventional incandescent bulbs are being replaced more and more often by light-emitting diodes (LEDs). In this case, endeavors are made to insert the light-emitting diodes into luminous bodies which imitate the optical appearance, the application possibilities and/or the emission behavior of incandescent bulbs. The optical appearance of typical incandescent bulbs includes, for example, a dome-shaped or spherical luminous body. The application possibilities of the incandescent bulb including, for example, screwing the incandescent bulbs equipped with screwthreads into corresponding bases of luminaires, such that the incandescent bulbs can serve as luminous means in the luminaires. The emission behavior of incandescent bulbs typically includes the fact that they emit their light uniformly virtually in all spatial directions. Such lighting devices that imitate incandescent bulbs with light-emitting diodes as radiation sources are also designated as retrofit lamps.

When using light-emitting diodes there is the problem, in principle, of dissipating the heat that arises in the light-emitting diodes during their operation. Particularly in the case of light-emitting diodes that emit white light, a large amount of heat arises since said diodes make use of light-emitting diodes which emit blue light and which heat up in the process and whose blue light excites phosphors in conversion elements which emit white conversion light, wherein, during the light conversion, the conversion elements heat up on account of the light power introduced into them. For the purpose of dissipating the heat that arises, it is known to use cooling bodies. However, such cooling bodies shield part of the light emitted by the light-emitting diodes, such that the light cannot be emitted in virtually all spatial directions. In other words, the cooling bodies cast shadows. This effect can be reduced by using small cooling bodies. However, as cooling bodies become smaller, although the shadow regions become smaller, the cooling effect of said cooling bodies also decreases.

### SUMMARY

In various embodiments, a lighting device is provided. The lighting device may include an air channel, which extends in an axial direction and which has at least one first opening in the region of a first axial end of the air channel and which has at least one second opening in the region of a second axial end of the air channel; at least one radiation arrangement, which emits electromagnetic radiation and which is arranged on an outer side of the air channel such that it emits the electromagnetic radiation in a direction away from the air channel; and at least one conversion element, which comprises phosphors and which is arranged around the air channel and the radiation arrangement at a predefined distance from the radiation arrangement such that the electromagnetic radiation impinges on the conversion element and excites the phosphors in the conversion element for emitting conversion radiation.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a section through one embodiment of a lighting device;

FIG. 2 shows a section through a further embodiment of a lighting device;

FIG. 3 shows a section through a further embodiment of a lighting device;

FIG. 4 shows a side view of a further embodiment of a lighting device;

FIG. 5 shows one embodiment of a radiation arrangement;

FIG. 6 shows a further embodiment of a radiation arrangement;

FIG. 7 shows a further embodiment of a radiation arrangement;

FIG. 8 shows a section through a further embodiment of a lighting device;

FIG. 9 shows a cooling body in side view; and

FIG. 10 shows a flow chart of an embodiment of a method for operating a lighting device.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

In the following detailed description, reference is made to the accompanying drawings, which form part of this description and show for illustration purposes specific exemplary embodiments in which the invention can be implemented. In this regard, direction terminology such as, for instance, “at the top”, “at the bottom”, “at the front”, “at the back”, “front”, “rear”, etc. is used with respect to the orientation of the figure(s) described. Since components of embodiments can be positioned in a number of different orientations, the direction terminology serves for illustration purposes and is not restrictive in any way whatsoever. It goes without saying that other embodiments can be used and structural or logical changes can be made, without departing from the scope of protection of the present invention. It goes without saying that the features of the various exemplary embodiments described herein can be combined with one another, unless specifically indicated otherwise. The following detailed description should therefore not be interpreted in a restrictive sense, and the scope of protection of the present invention is defined by the appended claims.

In the context of this description, the terms “connected” and “coupled” are used to describe both a direct and an indirect connection, and a direct or indirect coupling. In the figures, identical or similar elements are provided with identical reference signs, in so far as this is expedient.

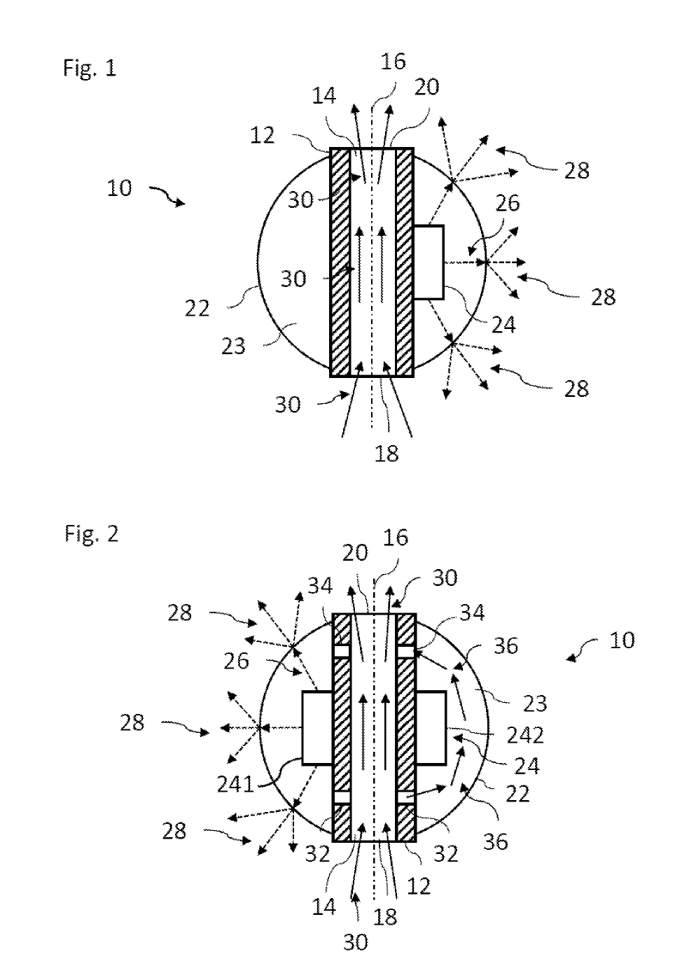

FIG. 1 shows one embodiment of a lighting device 10 in sectional illustration. The lighting device 10 includes an air channel 12. The air channel 12 has an interior 14. The air channel 12 extends in an axial direction that is parallel to an axis 16. The air channel 12 has a first opening 18 in the region of a first axial end of the air channel and a second opening 20 in the region of a second axial end of the air channel 12. By way of example, the first opening 18 serves as an air feed and the second opening 20 serves as an air discharge. By way of example, the first opening 18 is formed by the first axial end of the air channel 12 and the second opening 20 is formed by the second axial end of the air channel 12.

As an alternative or in addition to the first opening 18 illustrated and the second opening 20 illustrated, the air channel 12 can also have further first openings serving as an air feed and further second openings serving as an air discharge. By way of example, the further first openings are formed in a manner adjacent to the first axial end of the air channel 12, for example in a wall of the air channel 12. In a manner corresponding thereto, the second openings can be formed for example in a manner adjacent to the second axial end of the air channel 12, for example in a wall of the air channel 12.

The air channel 12 may be formed for example symmetrically with respect to the axis 16, for example rotationally symmetrically with respect to the axis 16. By way of example, the air channel 12 can be formed in a tubular fashion. As an alternative thereto, the air channel 12 can be formed for example as triangular, square, or hexagonal, in cross section.

The lighting device 10 furthermore includes a conversion element 22. The conversion element 22 is arranged for example around the air channel 12. By way of example, the conversion element 22 and the air channel 12 enclose an intermediate region 23. The conversion element 22 includes phosphors, for example one, two or more types of phosphor and/or a phosphor mixture. The phosphors may be for example phosphorescent or fluorescent phosphors. The phosphors may emit white, green or red light for example upon corresponding excitation. By way of example, the phosphors may include a Ce3+ doped garnet phosphor, e.g. yttrium aluminum garnet (YAG) or variants thereof having the general formula (Y,Lu,Gd)3(Al,Ga)5012:Ce3+ or mixtures of such a garnet phosphor with red-emitting, Eu2+ doped nitride phosphors of the type (Ca,Sr)AlSiN3:Eu2+ or (Ca,Sr,Ba)2Si5N8:Eu2+. Other phosphors known from remote phosphor applications are also conceivable, wherein it should be noted that in many remote phosphor applications, no phosphorus is used as phosphor, but phosphorus is in principle conceivable as phosphor. The conversion element 22 may be formed for example in a spherical fashion, in a dome-shaped fashion or in the shape of a chefs hat, wherein the specific shape of the conversion element 22 can be optimized for example with regard to light emission into the largest possible solid angle range, wherein the phosphors themselves can emit light isotropically in all spatial directions and this conversion light can mix with unconverted, for example blue, excitation light.

In the intermediate region 23, a radiation arrangement 24 is arranged on an outer side of the air channel 12, for example with physical contact with the wall of the air channel 12. The radiation arrangement 24 may include for example one, two or more radiation clusters and/or one, two or more radiation sources, as explained in greater detail with reference to the following figures. The radiation arrangement 24 emits electromagnetic radiation 26. By way of example, the radiation arrangement 24 emits light in the visible range or UV light. By way of example, the radiation arrangement 24 may emit blue or red light. The radiation arrangement 24 may be formed for example such that the electromagnetic radiation 26 is emitted away from the air channel 12 at least into the half-space around the lighting device 12.

The electromagnetic radiation 26 impinges on the conversion element 22. The electromagnetic radiation 26 excites the phosphors to luminesce in the conversion element. In this context, the electromagnetic radiation 26 can also be designated as excitation radiation. The excited phosphors then emit conversion radiation 28. In other words, the excitation radiation is converted into conversion radiation 28. Since the excited phosphor serves as a new, isotropically emitting radiation source, the conversion radiation 28 is emitted in a larger solid angle range than the electromagnetic radiation 26. Consequently, by arranging the conversion element 22 it is possible to enlarge an irradiated solid angle range.

Depending on the phosphors used, the conversion radiation 28 may include colored or white light, for example. In this case, the color of the light need not be identical to the color of the conversion element 22 in the switched-off state. The conversion element 22 may for example completely or almost completely prevent the electromagnetic radiation 26 from passing through the conversion element 22. As an alternative thereto, the conversion element 22 may be partly transmissive to the electromagnetic radiation 26 in a targeted manner, for example, such that a targeted mixture of excitation radiation with conversion radiation 28 is achieved, which can be used for the purpose of color control, for example. By way of example, white light can be generated by mixing blue transmitted excitation light with yellow conversion light from the phosphor.

During the operation of the lighting device 10, e.g. during the generation of the electromagnetic radiation 26, the radiation arrangement 24 heats up. On account of the radiation arrangement 24 heating up, a wall of the air channel 12 also heats up, e.g. in the region in which the radiation arrangement 24 is arranged on the outer side of the air channel 12. The heating of the wall of the air channel 12 leads to a heating of the air in the interior 14 of the air channel 12. With the aid of an air flow 30, represented with the aid of solid arrows in the figures, through the air channel 12, the heat that arises in the interior 14 may be dissipated from the air channel 12. If the lighting device 10 is oriented such that the air channel 12, and e.g. its axis 16, extends in a vertical direction, then the warm air rises upward in the interior 14, as a result of which a reduced pressure arises in the lower region of the air channel 12, as a result of which cold air is drawn into the air channel 12 through the first opening 18. The cold air takes up the heat in the interior 14 of the air channel 12 and warm outgoing air is forced out of the air channel 12 through the second opening 20 and dissipated directly to the environment. As a result, the air flow 30 through the air channel 12 is intensified and the air flow 30 through the air channel 12 sustains itself. This effect is also designated as the chimney effect. The chimney effect leads to an intensified air flow 30 and thus to intensified cooling of the air channel 12 and thus to intensified cooling of the radiation arrangement 24. Furthermore, the air flow 30 through the interior 14 improves a heat transfer coefficient from the wall of the air channel 12 toward the air into the interior 14, as a result of which the cooling effect of the air channel 12 is likewise intensified.

FIG. 2 shows a further embodiment of the lighting device 10. The lighting device 10 largely corresponds to the lighting device 10 illustrated in FIG. 1. In contrast to the lighting device 10 illustrated in FIG. 1, the lighting device 10 illustrated in FIG. 2 includes a radiation arrangement 24 having a first radiation cluster 241 and a second radiation cluster 242. The two radiation clusters 241, 242 are arranged on opposite outer sides of the air channel 12. The two radiation clusters 241, 242 emit the electromagnetic radiation 26 in opposite directions. In addition to the two radiation clusters 241, 242, even further radiation clusters can be arranged in a manner distributed around the circumference of the air channel 12. In interaction with the conversion element 23, the radiation clusters 241, 242 enable light to be emitted into the entire space or virtually the entire space of the environment of the lighting device 10. This is for example also possible by virtue of the air channel 12 being arranged as a cooling element for cooling the radiation clusters 241, 242 between the radiation clusters 241, 242 and on the rear sides thereof.

Furthermore, the lighting device 10 from FIG. 2 includes one, two or more third openings 32 between the first opening 18 and the radiation clusters 241, 242 of the radiation arrangement 24. The third openings 32 connect the interior 14 of the air channel 12 to the intermediate region 23, such that an air exchange between the interior 14 and the intermediate region 23 is possible. In other words, the interior 14 communicates with the intermediate region 23 via the third openings 32. Furthermore, the lighting device 10 from FIG. 2 includes one, two or more fourth openings 34 between the second opening 20 and the radiation clusters 241, 242 of the radiation arrangement 24. The fourth openings 34 connect the interior 14 of the air channel 12 to the intermediate region 23, such that an air exchange between the interior 14 and the intermediate region 23 is possible. In other words, the interior 14 communicates with the intermediate region 23 via the fourth openings 32.

The air flow 30 through the interior 40 brings about an air flow 36 through the intermediate region 23, wherein the air passes from the interior 14 through the third openings 32 into the intermediate region 23, an air flow 36 flows through the intermediate region 23 and the air passes back into the interior 14 again through the fourth openings 34. If the lighting device 10 is oriented in a vertical direction, then this is intensified by the chimney effect in the air channel 12. In addition, a chimney effect also occurs in the intermediate region 23 since, in the intermediate region 23, too, the warm air rises upward, that is to say from the third openings 32 toward the fourth openings 34. The air flow 36 through the intermediate region 23 flows past the radiation arrangement 24, for example past the radiation clusters 241, 242, such that these are cooled from the inside via the air channel 12 and from the outside via the intermediate region 23, that is to say on both sides. In addition, the air flow 36 through the intermediate region 23 cools the conversion element 23 from inside. In addition to the third openings 32 illustrated, fewer or more third openings 32 can be formed in the air channel, through which openings the intermediate region 23 can be supplied with air. In addition or as an alternative to the fourth openings 34, fewer or further fourth openings 34 can be formed in the air channel 12, through which openings the warm outgoing air can be dissipated from the intermediate region 23 into the air channel 12.

The electromagnetic radiation 26 is generated by both radiation clusters 241, 242 and correspondingly emitted. Equally, the conversion radiation 28 is generated on both sides of the air channel 12 in FIG. 2, the electromagnetic radiation 26 and the conversion radiation 28 being illustrated only on the left side of the air channel 12 in FIG. 2, for reasons of clarity. Equally, the air flow 36 through the intermediate region 23 arises both between the first radiation cluster 241 and the conversion element 22 and between the second radiation cluster 242 and the conversion element 22, this being illustrated only on the right side of the air channel 12 in FIG. 2, for reasons of clarity. In reality, in this embodiment of the lighting device 10, both the radiation and the air flows 36 through the intermediate region 23 are generated symmetrically with respect to the axis 16.

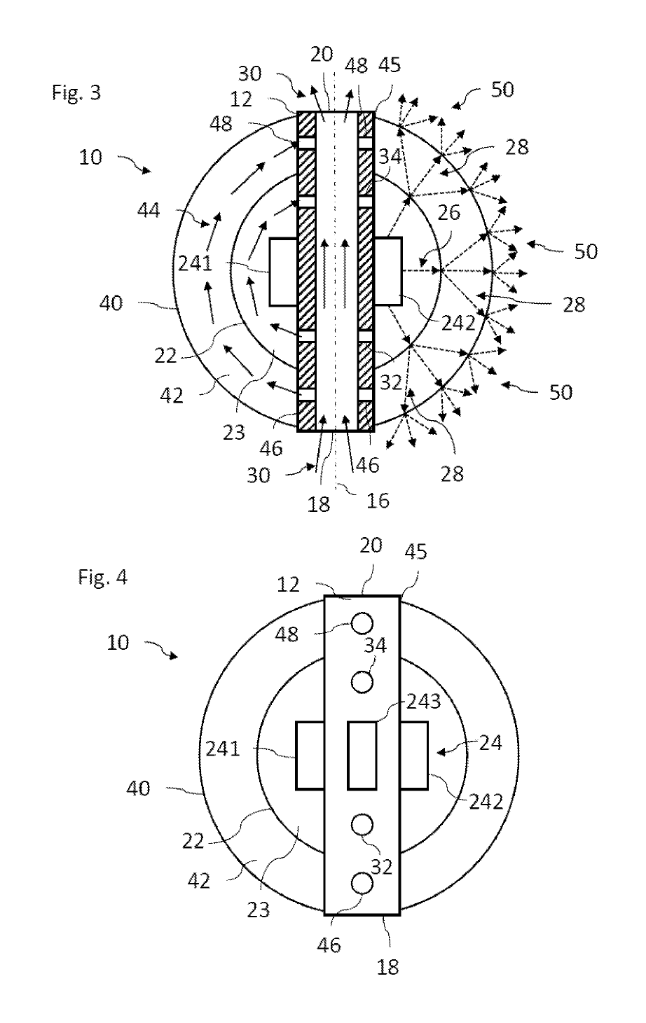

FIG. 3 shows a further embodiment of the lighting device 10. The lighting device 10 shown in FIG. 3 includes all the elements of the lighting device 10 shown in FIG. 2. In addition, the lighting device 10 shown in FIG. 3 includes the air channel 12 which is lengthened compared with the air channel 12 explained above. A diffuser body 40 is arranged around the air channel 12, wherein the air channel 12 communicates with an environment of the diffuser body 40 and thus with an environment of the lighting device 10 via the diffuser opening 45. The diffuser body 40 serves for scattering the conversion radiation 28. The scattered conversion radiation is emitted as scattered light 50 in all spatial directions. The diffuser body 40 is arranged at a predefined distance from the conversion element 22 inter alia for reasons of enabling better illustration. However, the conversion element 22 can also be arranged at a significantly smaller distance from the diffuser body 40.

The diffuser body 40 may be formed in a translucent fashion, for example, which in this context means that although the conversion radiation 28 and also light in part may pass through the diffuser body 40 from outside, to an observer the diffuser body 40 appears to be non-transparent from outside. By way of example, the diffuser body 40 can be formed such that the conversion element 22 and/or the air channel 12 are/is not discernible to the observer through the diffuser body 40. The diffuser body 40 can be formed for example such that it appears to be white to the observer when the lighting device 10 is in the switched-off state. By way of example, the diffuser body 40 may include glass, for example milk glass, or plastic, for example plastic with light-scattering particles. The diffuser body 40 can be formed for example in a spherical fashion, in a dome-shaped fashion or in the shape of a chef's hat, wherein the specific shape of the diffuser body 40 can be optimized for example with regard to optimum emission of the scattered light in all spatial directions.

The diffuser body 40 and the air channel 12 and the conversion element 22 enclose an outer region 42. In the outer region 42, the conversion radiation 28 passes from the conversion element 22 toward the diffuser body 40. The air channel 12 has fifth openings 46, which are arranged in an axial direction between the first opening 18 and the radiation arrangement 24, for example between the first opening 18 and the third openings 32. The fifth openings 46 are furthermore arranged and formed such that the interior 14 of the air channel 12 communicates with the outer region 42 via the fifth openings 46. In other words, air passes from the interior 14 of the air channel 12 via the fifth openings 46 into the outer region 42. The air channel has sixth openings 46, which are arranged in an axial direction between the second opening 20 and the radiation arrangement 24, for example between the second opening 20 and the fourth openings 34. The sixth openings 48 are furthermore arranged and formed such that the interior 14 of the air channel 12 communicates via the sixth openings 46 with the outer region 42. In other words, air passes from the outer region 42 via the fifth openings 46 into the interior 14 of the air channel 12.

During the operation of the lighting device 10, on account of the air flow 30 through the interior 14 of the air channel 12, an air flow 44 also arises through the outer region 42, which is illustrated by solid arrows in FIG. 3. Given vertical orientation of the lighting device 10, the air flow 44 through the outer region 42 is intensified by the chimney effect in the air channel 12 and by a further chimney effect in the outer region 42. The air flow 44 through the outer region 42 cools the conversion element 22 from outside. This contributes to being able to introduce a high light power into the conversion element 22, without heating the conversion element 22 to an excessively great extent. The flow of cooling air around the conversion element 22 on both sides makes it possible for the heat that arises in the conversion element 22 to be transported away better than would be possible on account of the heat conduction of the conversion element 22 alone. Consequently, with the same geometry of the conversion element 22, larger quantities of heat can be transported away more rapidly and/or lower temperatures of the conversion element 22 can be realized by comparison with a closed construction of the lighting device without an air channel 12 having corresponding openings 46, 48, 32, 34.

FIG. 4 shows a further embodiment of the lighting device 10. The lighting device 10 shown in FIG. 4 substantially corresponds to the lighting device 10 shown in FIG. 3, wherein the air channel 12 and the radiation arrangement 42 having the first radiation cluster 241, the second radiation cluster 242 and a third radiation cluster 243 are illustrated in side view. The conversion element 22 and the diffuser body 40 are illustrated in sectional view in accordance with FIG. 3. In addition, the lighting device 10 may include a further radiation cluster on the rear side (not shown) of the air channel 12. As an alternative thereto, the three radiation clusters 241, 242, 243 shown may be distributed uniformly around the circumference of the air channel 12. The radiation clusters 241, 242, 243 and, if appropriate, further radiation clusters can be arranged for example symmetrically about the axis 16 of rotation. By way of example, the radiation clusters 241, 242, 243 can be arranged with an angular distance between their mid-points of 120° uniformly around the circumference of the air channel 12. Furthermore, one of the third openings 32, one of the fourth openings 34, one of the fifth openings 46, and one of the sixth openings 48 are illustrated in front view. The electromagnetic radiation 26 emitted by the radiation clusters 241, 242, 243 is emitted in a direction away from the air channel 12. Consequently, the air channel 12, which serves as a cooling body for the radiation clusters 241, 242, 243, shades only very little to no electromagnetic radiation 26 at all.

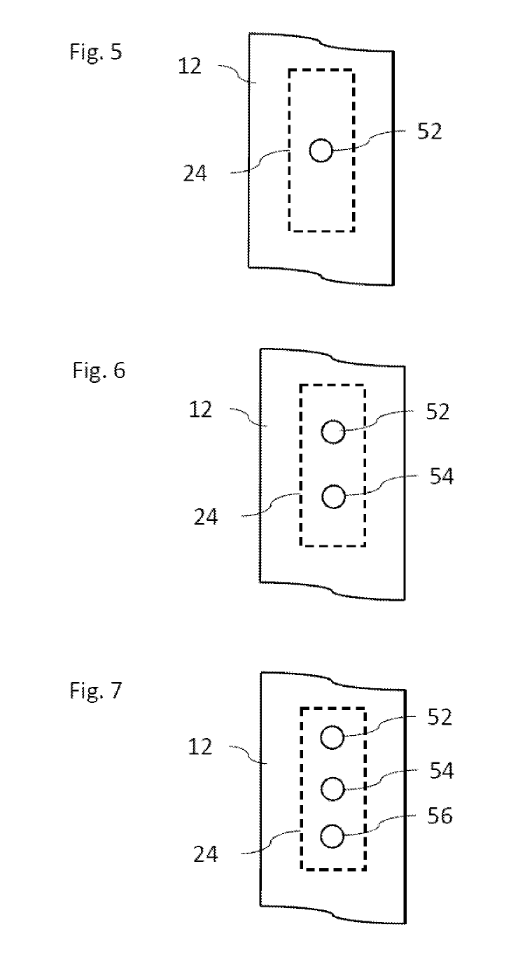

FIG. 5 shows a detail view of the air channel 12 with one embodiment of the radiation arrangement 24. By way of example, FIG. 5 shows one of the radiation clusters explained above. In this embodiment, the radiation arrangement 24 has a first radiation source 52. The first radiation source 52 can be a light-emitting diode, for example. By way of example, the first radiation source 52 can emit blue or red light or UV light.

FIG. 6 shows a detail view of the air channel 12 with a further embodiment of the radiation arrangement 24. By way of example, FIG. 6 shows one of the radiation clusters explained above. In this embodiment, the radiation arrangement 24 has the first radiation source 52 and a second radiation source 54. The second radiation source 54 can be a light-emitting diode, for example. By way of example, the second radiation source 52 can emit blue or red light or UV light. By way of example, the first and second radiation sources 52, 54 can both emit blue light. As an alternative thereto, by way of example, the first radiation source 52 can emit blue light and the second radiation source 54 can emit red light.

FIG. 7 shows a detail view of the air channel 12 with a further embodiment of the radiation arrangement 24. By way of example, FIG. 7 shows one of the radiation clusters explained above. In this embodiment, the radiation arrangement 24 has the first radiation source 52, the second radiation source 54 and a third radiation source 56. The third radiation source 54 can be a light-emitting diode, for example. By way of example, the third radiation source 52 can emit blue or red light or UV light. By way of example, the first and second radiation sources 52, 54 can both emit blue light and the third radiation source 56 can emit red light.

The radiation sources 52, 54, 56 are arranged one behind another in an axial direction. Given vertical orientation of the lighting device 10, the radiation sources 52, 54, 56 are arranged one above another. This can contribute to the conversion radiation 28 and/or the scattered light 50 being emitted as uniformly as possible in all spatial directions.

Depending on the color of the light which is intended to be produced by the lighting device 10, the radiation sources 52, 54, 56 and the conversion element 22 can be coordinated with one another. By way of example, with the aid of blue light, yellow phosphorus can be excited to emit white light. Additionally or alternatively, the conversion element 22 may be formed such that it is at least partly transmissive to the electromagnetic radiation 26, such that, by way of example, part of the blue excitation light and/or of the red light passes through the conversion element 22 and mixes with the conversion radiation 28. By way of example, admixing red light with the conversion radiation 28 makes it possible to produce warm-white illumination light. In contrast thereto, by way of example, without admixing red light, cold-white illumination light can be generated. As an alternative thereto, with exclusively blue excitation radiation, the conversion element 22 may include phosphors which emit yellow and red conversion light, as a result of which warm-white illumination light can once again be generated.

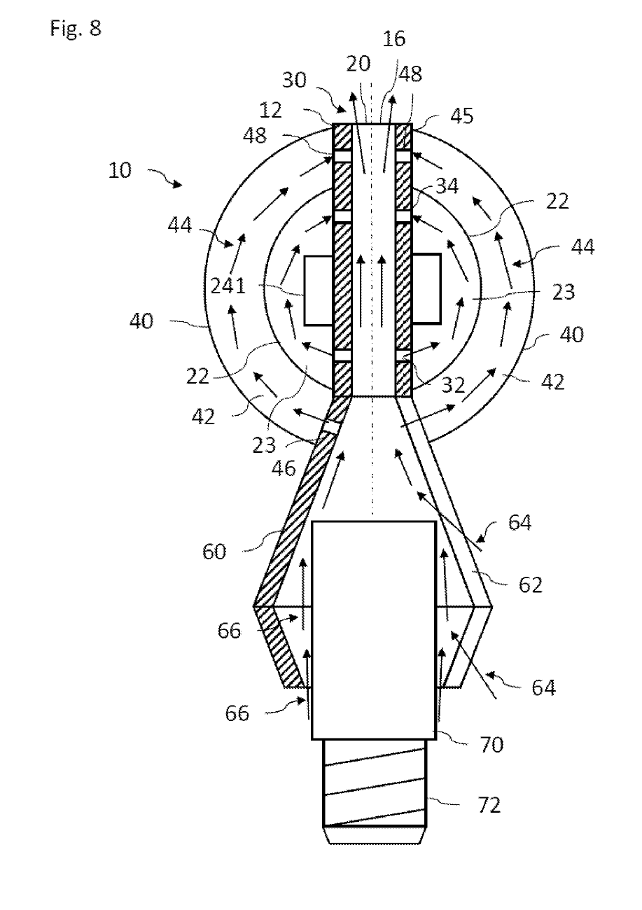

FIG. 8 shows an embodiment of the lighting device 10 which substantially corresponds to the embodiments of the lighting device 10 as shown in FIG. 4 and FIG. 5. In addition to the lighting device 10 shown in FIG. 4 and FIG. 5, the lighting device 10 shown in FIG. 8 includes a cooling body 60 connected to the air channel 12. The cooling body 60 has a plurality of cooling ribs 62 between which an air flow 64 can flow into the cooling body 60 from outside. Furthermore, the cooling body 60 can be formed such that from below, too, an inner air flow 66 can flow through the cooling body 60 and can mix with the air flow 64 from outside. The cooling body 60 is formed for example such that it surrounds a control unit 70, with the aid of which the radiation arrangement 24 can be driven and/or can be supplied with current. Consequently, the cooling body 60 serves inter alia for cooling the control unit 70. Furthermore, the cooling body 60 serves as an extension of the air channel 12, as a result of which the chimney effect can be intensified. The control unit 70 can have a screwthread 72, for example, by means of which the lighting device 10 can be screwed into a holder for a conventional incandescent bulb. Furthermore, the diffuser body 10 can be formed in a manner corresponding to a conventional incandescent bulb in terms of appearance, shape and/or size. In other words, the lighting device 10 can imitate a conventional incandescent bulb. In this context, the lighting device 10 can also be designated as a retrofit lamp.

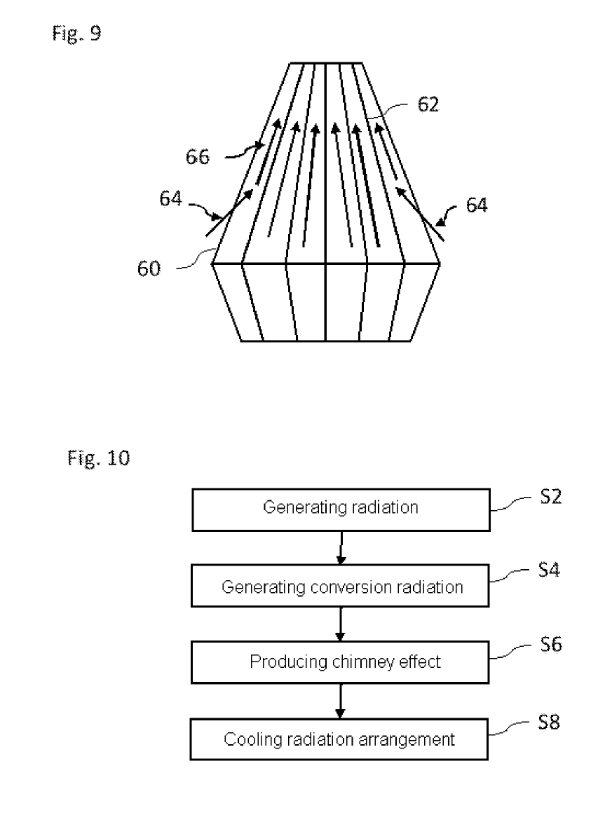

FIG. 9 shows the cooling body 60 from outside, wherein the cooling ribs 62 are indicated as straight lines running from the bottom to the top.

FIG. 10 shows a flow chart of one embodiment of a method for operating a lighting device, for example the lighting device 10. The method serves to make it possible to operate the lighting device 10 with a high light power in conjunction with sufficient cooling capacity.

A step S2 involves generating electromagnetic radiation, for example the electromagnetic radiation 26, for example with the aid of the radiation arrangement 24. The electromagnetic radiation 26 can also be designated as excitation radiation. The electromagnetic radiation 26 is generated for example such that it is emitted into a solid angle range that is as large as possible.

A step S4 involves converting the electromagnetic radiation 26 into conversion radiation, for example into the conversion radiation 28, for example with the aid of the conversion element 22. The conversion radiation 28 is generated for example such that it is emitted into a solid angle range that is as large as possible, wherein the solid angle range covered by the conversion radiation 28 can be for example larger than the solid angle range covered by the electromagnetic radiation 26 in step S2. In addition, the emitted conversion radiation 28 can be scattered still further, for example with the aid of the diffuser body 40.

A step S6 involves producing a chimney effect, for example with the aid of the air channel 12. By way of example, the chimney effect is produced by evolution of heat in the radiation arrangement 24 and the transfer of the heat to the wall of the air channel 12 and by evolution of heat in the conversion element 22. The chimney effect can be produced for example by the axis 16 of the air channel 12 being oriented vertically at least with one direction component of the axis 16. This can be achieved for example by a vertical orientation of the lighting device 10.

In a step S8, the chimney effect brings about the air flow 30 through the interior 14 of the air channel 12, as a result of which the radiation arrangement 10 is cooled.

When the lighting device 10 is started, steps S2 to S8 successively proceed automatically in the lighting device 10. During continuous operation of the lighting device 10, steps S2 to S8 proceed permanently and/or simultaneously in the lighting device 10. When the lighting device 10 is switched off, e.g. when the radiation arrangement 24 is switched off, the chimney effect can still be maintained until the lighting device 10 is at ambient temperature. The method and thus steps S2 to S8 can thus be processed for example with the aid of the lighting device 10.

The invention is not restricted to the exemplary embodiments specified. By way of example, the lighting device 10 may include a conversion element 22 or a diffuser body 40 having a different form. Furthermore, the radiation arrangement 24 can have more or fewer radiation clusters and/or more or fewer radiation sources. Furthermore, the lighting device 10 may include the diffuser body 40 but no fifth and sixth openings 46, 48. Furthermore, the exemplary embodiments of the lighting device 10 illustrated without a control unit 70 can also have a corresponding control unit 70. Furthermore, all the air channels 12 illustrated can have more or fewer openings for feeding cooling air into the corresponding air channel 12 or for dissipating heat from the corresponding air channel 12 or for feeding air into the corresponding outer region 42 and/or the corresponding intermediate region 24. Furthermore, an LED that emits red light can also be combined with an LED that emits UV light.

Various embodiments provide a lighting device and a method for operating a lighting device which make it possible to emit light into a large solid angle range and/or to generate a high light power in conjunction with sufficient cooling. Furthermore, a lighting device and a method for operating a lighting device are provided which make it possible largely to imitate the properties of a conventional incandescent bulb with the use of light-emitting diodes as radiation source.

In various embodiments, a lighting device is provided. The lighting device includes an air channel, at least one radiation arrangement and at least one conversion element. The air channel extends in an axial direction and has at least one first opening in the region of a first axial end of the air channel and at least one second opening in the region of a second axial end of the air channel. The radiation arrangement emits electromagnetic radiation and is arranged on an outer side of the air channel such that it emits the electromagnetic radiation in a direction away from the air channel. The conversion element including phosphors is arranged around the air channel and the radiation arrangement at a predefined distance from the radiation arrangement such that the electromagnetic radiation impinges on the conversion element and excites the phosphors in the conversion element for emitting conversion radiation.

Arranging the radiation arrangement at the predefined distance from the conversion element makes it possible, in a simple and effective manner, to generate light of different colors or white light. The radiation arrangement may include for example a light-emitting diode, for example a light-emitting diode that emits blue light, and the conversion element may include for example fluorescent phosphors, for example yellow phosphor. The blue light of the light-emitting diode can serve as excitation radiation for exciting the phosphor in the conversion element. The conversion radiation that arises as a result can then be white, for example. This principle can be designated for example as the remote phosphor principle, where “phosphor” should not be confused with “phosphorus”. The remote phosphor principle and/or remote phosphor applications can thus manage entirely without phosphorus as phosphor. Furthermore, the radiation arrangement can also have a light-emitting diode that emits UV light or a light-emitting diode that emits red light. Furthermore, the radiation arrangement can have a plurality of radiation sources, for example a plurality of light-emitting diodes, which each emit the same or different electromagnetic radiation.

The radiation arrangement is arranged on the outer side of the air channel for example in direct, physical contact with a wall of the air channel. The radiation arrangement can also have a heat sink via which it is directly coupled to the air channel. This enables a particularly good heat transfer from the radiation arrangement to the wall of the air channel. Heat arises when the electromagnetic radiation is generated in the radiation arrangement. Moreover, heat arises in the conversion element during the conversion of the excitation radiation into conversion radiation, wherein the conversion radiation may include white light, for example. The heat that arises in the radiation arrangement is dissipated via the wall of the air channel, inter alia, said heat being dissipated from the lighting device by an air flow through an interior of the air channel. In addition, with suitable orientation of the lighting device, for example such that the axial direction of the air channel extends at least partly in a vertical direction, this makes it possible to produce a chimney effect in the interior of the air channel, which effect intensifies the air flow through the air channel and thus the cooling effect of the air channel and thus the cooling of the radiation arrangement.

The chimney effect, also called natural draft, is a physical effect that describes a generally vertically directed air flow. Warm air has a lower density than cold air, and this gives rise to a lift in the air channel. Owing to the resultant reduced pressure in the lower region of the air channel, new air is drawn in, which fosters the originating cause of this effect, that is to say the rising of warm air, and leads to the effect being self-sustaining, which constitutes a positive feedback. The virtually adiabatic isolation of the hot air flow in the chimney is conducive to higher flow velocities of the air flow, which enables better heat transfer. By means of an artificial chimney such as the air channel of the lighting device, the air flow is directed and can be accelerated better than in the case of open arrangements, provided that it is correspondingly vertically oriented and/or suitably dimensioned. Furthermore, the air flow through the interior of the air channel may improve a heat transfer coefficient from the wall of the air channel to the air in the interior of the air channel. In addition to an outer side of the lighting device that emits heat to the environment, the wall of the air channel thus forms in the interior of the lighting device an additional cooling area which casts no shadow at all or at least only little shadow and dissipates the heat directly to the environment. The air channel thus serves as a cooling body for the radiation sources of the radiation arrangement. The improved cooling effect makes it possible to reduce the size of the cooling areas and thus to reduce the size of the air channel and thus to reduce the size of the lighting device with the light power remaining the same, or makes possible a higher light power with the size of the lighting device remaining the same, for example corresponding to a conventional incandescent bulb, compared with a lighting device without an air channel.

The first opening is formed for example by the first axial end of the air channel. The second opening is formed for example by the second axial end of the air channel. As an alternative or in addition to the first opening formed by the first axial end of the air channel, one, two or more further first openings may also be formed in the region of the first axial end of the air channel or adjacent to said axial end, wherein the first openings serve for example as an air feed for the air channel. As an alternative or in addition to the second opening formed by the second axial end of the air channel, one, two or more further second openings can also be formed in the region of the second axial end of the air channel or adjacent to the second axial end, wherein the second openings serve for example as an air discharge of the air channel. The first and second openings may for example also be formed in the wall of the air channel and/or extend in a radial direction.

In various embodiments, the conversion element and the air channel together enclose an intermediate region, which is formed in an axial direction between the first opening and the second opening and in which the radiation arrangement is arranged. The air channel has a third opening, which is formed in an axial direction between the first opening and the radiation arrangement and via which the intermediate region communicates with the air channel. The air channel has a fourth opening, which is formed in an axial direction between the second opening and the radiation arrangement and via which the intermediate region communicates with the air channel. The fact that the intermediate region communicates with the air channel means that an air exchange between the intermediate region and an interior of the air channel is possible. Consequently, the third and fourth openings make possible an air flow from the air channel into the intermediate region, through the intermediate region and back again into the air channel, as a result of which the radiation arrangement, arranged between the third and fourth openings, can be cooled from both sides, that is to say from inside by the air channel itself and from outside by means of the air flow through the intermediate region. This makes it possible to use a particularly powerful circuit arrangement and nevertheless to effectively and sufficiently dissipate the heat that arises in this case.

Furthermore, the air flow through the intermediate region also cools an inner side of the conversion element. This enables a high radiation power of electromagnetic radiation or excitation radiation to be able to be introduced into the conversion element and at the same time the conversion element to be able to be sufficiently cooled. By way of example, in embodiments wherein a large amount of heat is generated in the conversion element during the operation of the lighting device, as a result the maximum achievable light power can be increased or, for a given light power, the temperature of the conversion element may be reduced, which has an advantageous effect on the efficiency and lifetime of this component.

In various embodiments, the lighting device includes a diffuser body. The diffuser body is formed and arranged around the conversion element such that the conversion radiation impinges on the diffuser body, wherein the diffuser body has a diffuser opening via which the air channel communicates with an environment of the lighting device and e.g. with an environment of the diffuser body. Consequently, the air channel extends not only through the conversion element, but also through the diffuser body. The diffuser body includes for example glass or plastic, for example milk glass, roughened glass, which may be produced for example with the aid of sandblasting, or plastic including white scattering particles. The diffuser body may be formed such that the diffuser body appears white when the lighting device is in the switched-off state. The diffuser body may be formed for example in spherical fashion, in the shape of a chef's hat or in the form of a cap.

In various embodiments, the diffuser body and the conversion element enclose an outer region. The air channel has a fifth opening, which is formed in an axial direction between the first opening and the radiation arrangement via which the outer region communicates with the air channel. The air channel has a sixth opening, which is formed in an axial direction between the second opening and the radiation arrangement and via which the outer region communicates with the air channel. The fifth and sixth openings make possible an air flow from the air channel through the fifth opening into the outer region, through the outer region and through the sixth opening back into the air channel. As a result, the conversion element can be cooled from outside. In interaction with the air flow through the intermediate region, this enables the conversion element to be cooled on both sides. Furthermore, the air flow through the intermediate region cools the diffuser body from inside. Since the diffuser body can emit the heat toward the outside in a simple manner to the environment, the diffuser body is thus also cooled by air from both sides.

In various embodiments, the radiation arrangement has a first and at least one second radiation source, which are arranged one behind another in an axial direction. In other words, with vertical orientation of the air channel, the radiation sources are arranged one above the other. The radiation sources arranged one above another can emit for example radiation having an identical or different wavelength, for example light having an identical color or a different color. By way of example, one of the radiation sources can emit blue light and one of the radiation sources can emit red light or both radiation sources can emit blue light.

In various embodiments, the radiation arrangement has a first radiation cluster and at least one second radiation cluster, which are arranged at a predefined distance from one another along the outer side of the air channel, wherein each radiation cluster has at least one of the radiation sources. By way of example, the radiation clusters are distributed around the circumference of the air channel. With vertical orientation of the lighting device, the radiation clusters are arranged for example at the same level. One, two or more radiation sources can be arranged within a radiation cluster. By way of example, in a radiation cluster two or three radiation sources can be arranged one above another and, by way of example, two, three or four radiation clusters of this type can be arranged around the circumference of the air channel. This makes it possible to emit the electromagnetic radiation in virtually all spatial directions, e.g. also because the cooling body for cooling the radiation sources, that is to say the air channel, lies behind the radiation sources in the emission direction and the radiation sources are arranged around the air channel.

In various embodiments, for the purpose of controlling the radiation arrangement, a control unit is arranged in a manner adjacent to the first axial end of the air channel. For the purpose of cooling the control unit and/or for the purpose of lengthening the air channel, a cooling body is arranged on an outer side of the control unit. The cooling body has cooling channels which communicate with the air channel. The cooling body makes it possible firstly to be able to operate the control unit with a high power without overheating said control unit, and secondly to lengthen the air channel, as a result of which the chimney effect can be intensified. The control unit may also be designated as a driver or have a driver.

In various embodiments, the radiation arrangement includes at least one light-emitting diode as radiation source. In addition to the one light-emitting diode, the radiation arrangement may include as further radiation sources likewise light-emitting diodes or some other radiation source. By way of example, each radiation cluster may have a plurality of light-emitting diodes.

In various embodiments, at least one radiation source of the radiation arrangement emits blue light. Alternatively or additionally, one, two or more further radiation sources may emit blue light, red light or UV light.

In various embodiments, at least one radiation source of the radiation arrangement emits red light.

In various embodiments, the conversion element includes one or a plurality of phosphors.

Suitable phosphors are known in the prior art. Customary phosphors are for example garnets or nitrides, silicates, nitrides, oxides, phosphates, borates, oxynitrides, sulfides, selenides, aluminates, tungstates, and halides of aluminum, silicon, magnesium, calcium, barium, strontium, zinc, cadmium, manganese, indium, tungsten and other transition metals, or rare earth metals such as yttrium, gadolinium or lanthanum, which are doped with an activator such as, for example copper, silver, aluminum, manganese, zinc, tin, lead, cerium, terbium, titanium, antimony or europium. In various embodiments of the invention, the phosphor is an oxidic or (oxy-)nitridic phosphor such as a garnet, orthosilicate, nitrido(alumo) silicate, nitride or nitrido orthosilicate, or a halide or halophosphate. Concrete examples of suitable phosphors are strontiumchloroapatite:Eu ((Sr,Ca)5(PO4)3Cl:Eu; SCAP), yttrium aluminum garnet:cerium (YAG:Ce) or CaAlSiN3:Eu. By way of example, the phosphors may include a Ce3+ doped garnet phosphor, e.g. yttrium aluminum garnet (YAG) or variants thereof having the general formula (Y,Lu,Gd)3(Al,Ga)5O12:Ce3+ or mixtures of such a garnet phosphor with red-emitting, Eu2+ doped nitride phosphors of the type (Ca,Sr)AlSiN3:Eu2+ or (Ca,Sr,Ba)2Si5N8:Eu2+. Furthermore, the phosphor or phosphor mixture can contain for example particles having light-scattering properties and/or auxiliary substances. Examples of auxiliary substances include surfactants and organic solvents. Examples of light-scattering particles are gold, silver and metal oxide particles. The converter element can for example consist completely or only partly of crystal or ceramic. Furthermore, by way of example, the crystal converter element may be a single crystal. Independently thereof, the converter element may include a matrix material, which may include for example diamond or Al2O3. Other phosphors known from remote phosphor applications are also conceivable.

Various embodiments provide a method for operating the lighting device. With the aid of the radiation arrangement electromagnetic radiation is generated and emitted in the direction toward the conversion element spaced apart from the radiation arrangement. On account of the electromagnetic radiation impinging on the conversion element, phosphors are excited for emitting conversion radiation in the conversion element. The lighting device is cooled by heat that arises during the generation of the electromagnetic radiation and/or of the conversion radiation being transported away by air cooling via the air channel, on the outer side of which the radiation arrangement is arranged. Furthermore, the heat is also emitted in the form of thermal radiation and/or by means of thermal conduction in the solid body.

In various embodiments, for the purpose of intensifying the cooling effect, the lighting device is arranged such that, on account of the heat in the air channel, a chimney effect is produced in the air channel, which brings about an air flow in the air channel. By way of example, the air flow is directed upward in a vertical direction. If the air channel has the third, fourth, fifth and/or sixth opening, the upwardly directed air flow through the interior of the air channel also brings about correspondingly upwardly directed air flows through the intermediate region and the outer region, as a result of which the radiation sources, the conversion element and/or the diffuser body are in each case cooled on both sides. In various embodiments, the lighting device is arranged such that at least one direction component of an axial direction in which the air channel extends is oriented vertically. This makes it possible to produce the chimney effect. In this case, even a small difference in pressure and/or temperature between the axial ends of the air channel suffices for producing the chimney effect. With increasingly vertical orientation, however, the action of the chimney effect also improves.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting device, comprising
an air channel, which extends in an axial direction and which has at least one first opening in the region of a first axial end of the air channel and which has at least one second opening in the region of a second axial end of the air channel;
at least one radiation arrangement, which emits electromagnetic radiation and which is arranged on an outer side of the air channel such that it emits the electromagnetic radiation in a direction away from the air channel; and
at least one conversion element, which comprises phosphors and which is arranged around the air channel and the radiation arrangement at a predefined distance from the radiation arrangement such that the electromagnetic radiation impinges on the conversion element and excites the phosphors in the conversion element for emitting conversion radiation.

2. The lighting device as claimed in claim 1,
wherein the conversion element and the air channel together enclose an intermediate region, which is formed in an axial direction between the first opening and the second opening and in which the radiation arrangement is arranged;
wherein the air channel has a third opening, which is formed in an axial direction between the first opening and the radiation arrangement and via which the intermediate region communicates with the air channel; and
wherein the air channel has a fourth opening, which is formed in an axial direction between the second opening and the radiation arrangement and via which the intermediate region communicates with the air channel.

3. The lighting device as claimed in claim 1, further comprising:
a diffuser body, which is formed and arranged around the conversion element such that the conversion radiation impinges on the diffuser body and at least partly penetrates through the diffuser body, wherein the diffuser body has at least one diffuser opening via which the air channel communicates with an environment of the lighting device.

4. The lighting device as claimed in claim 3,
wherein the diffuser body and the conversion element enclose an outer region;
wherein the air channel has a fifth opening, which is formed in an axial direction between the first opening and the radiation arrangement via which the outer region communicates with the air channel; and
wherein the air channel has a sixth opening, which is formed in an axial direction between the second opening and the radiation arrangement and via which the outer region communicates with the air channel.

5. The lighting device as claimed in claim 1,
wherein the radiation arrangement has a first and at least one second radiation source, which are arranged one behind another in an axial direction of the air channel.

6. The lighting device as claimed in claim 1,
wherein the radiation arrangement has a first radiation cluster and at least one second radiation cluster, which are arranged at a predefined distance from one another along the outer side of the air channel, wherein each radiation cluster has at least one radiation source.

7. The lighting device as claimed in claim 1,
wherein, for the purpose of controlling the radiation arrangement, a control unit is arranged in a manner adjacent to the first axial end of the air channel and wherein, at least one of for the purpose of cooling the control unit and for the purpose of intensifying a chimney effect in the air channel, a cooling body is arranged on an outer side of the control unit, wherein the cooling body has cooling channels that communicate with the air channel.

8. The lighting device as claimed in claim 1,
wherein the radiation arrangement has at least one light-emitting diode as radiation source.

9. The lighting device as claimed in claim 1,
wherein at least one radiation source of the radiation arrangement emits blue light.

10. The lighting device as claimed in claim 1,
wherein at least one radiation source of the radiation arrangement emits red light.

11. The lighting device as claimed in claim 1,
wherein the conversion element comprises one or a plurality of garnet phosphors as phosphor.

12. A method for operating a lighting device, the method comprising:
generating and emitting with the aid of a radiation arrangement electromagnetic radiation in the direction toward a conversion element spaced apart from the radiation arrangement;
exciting, on account of the electromagnetic radiation impinging on the conversion element, phosphors for emitting conversion radiation in the conversion element; and
cooling the lighting device by heat that arises during the generation of at least one of the electromagnetic radiation and of the conversion radiation being transported away by air cooling via an air channel, on the outer side of which the radiation arrangement is arranged.

13. The method as claimed in claim 12,
wherein, for the purpose of intensifying the cooling effect, the lighting device is arranged such that, on account of the heat in the air channel, a chimney effect is produced in the air channel, which brings about a heat-dissipating air flow in the air channel.

14. The method as claimed in claim 13,
wherein the lighting device is arranged such that at least one direction component of an axial direction in which the air channel extends is oriented vertically.
